(19) United States
(12) Patent Application Publication
(10) Pub. No.: US 2006/0114259 A1
(43) Pub. Date: Jun. 1, 2006

(54) Method for displaying picture animation on a display

(75) Inventor: Shih-Hua Tseng, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Tatung Company, Taipei City (TW)

(21) Appl. No.: 11/289,592

(22) Filed: Nov. 30, 2005

(30) Foreign Application Priority Data
Dec. 1, 2004 (TW) 093137072

(51) Int. Cl. G06T 15/70

(52) U.S. Cl. 345/473

(57) ABSTRACT

A method for displaying a picture animation on a display utilizes execution of an OSD chip to present a picture animation, whereby both a power-on image from a computer and the monitor picture animation can be displayed at the same time. A user does not need to wait for the picture animation to finish displaying before seeing start-up information. The display can display the picture animation with or without use of a synchronization signal.

### BACKGROUND OF THE INVENTION

1. Field of the Invention

The present invention relates to a method for displaying picture animation on a display, and more particularly, to method for displaying picture animation on a display controlled by an OSD chip.

2. Description of the Related Art

Generally, a trademark is presented on a surface of a monitor, and some monitors display a static or animating trademark image when the monitor is turned on. However, the displaying manner is determined when the product is manufactured, and cannot be changed.

The prior art computer displays a power-on image after presentation of the trademark or picture animation has finished; the power-on image and the trademark image or picture animation cannot be displayed at the same time. Therefore, a user must wait for some time before he or she can begin operating the computer. Therefore, it is desirable to provide a method for displaying picture animation on a display to mitigate and/or obviate the aforementioned problems.

### SUMMARY OF THE INVENTION

The present invention provides a method for displaying picture animation on a display, which comprises: (A) initialization; (B) detecting whether there is an input synchronization signal; if there is an input synchronization signal, the display displays an image according to the synchronization signal; otherwise a microprocessor of the display outputs a control signal to drive the display; (C) determining whether there is an input picture animation signal; if there is an input picture animation signal, the display displays the picture animation; and (D) determining whether there is an input stop signal; if there is an input stop signal, display of the picture animation is stopped; otherwise display of the picture animation continues until finished; wherein the picture animation is displayed by an OSD chip (On Screen Display). The microprocessor of the display further comprises a re-writeable memory for storing the picture animation, the picture animation is hexadecimal program code. Furthermore, the present invention helps the user to download pictures from the Internet.

The method of the present invention utilizes execution of the OSD chip to present a picture animation, whereby both a power-on image from a computer and the monitor picture animation can be displayed at the same time. Thus, a user does not need to wait for the picture animation to finish displaying before seeing start-up information.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a preferred embodiment according to the present invention.

FIG. 2 is a functional block drawing of the preferred embodiment according to the present invention.

FIG. 3 is a functional block drawing of another preferred embodiment according to the present invention.

### DETAILED DESCRIPTION OF THE PREFERRED EMBODIMENT

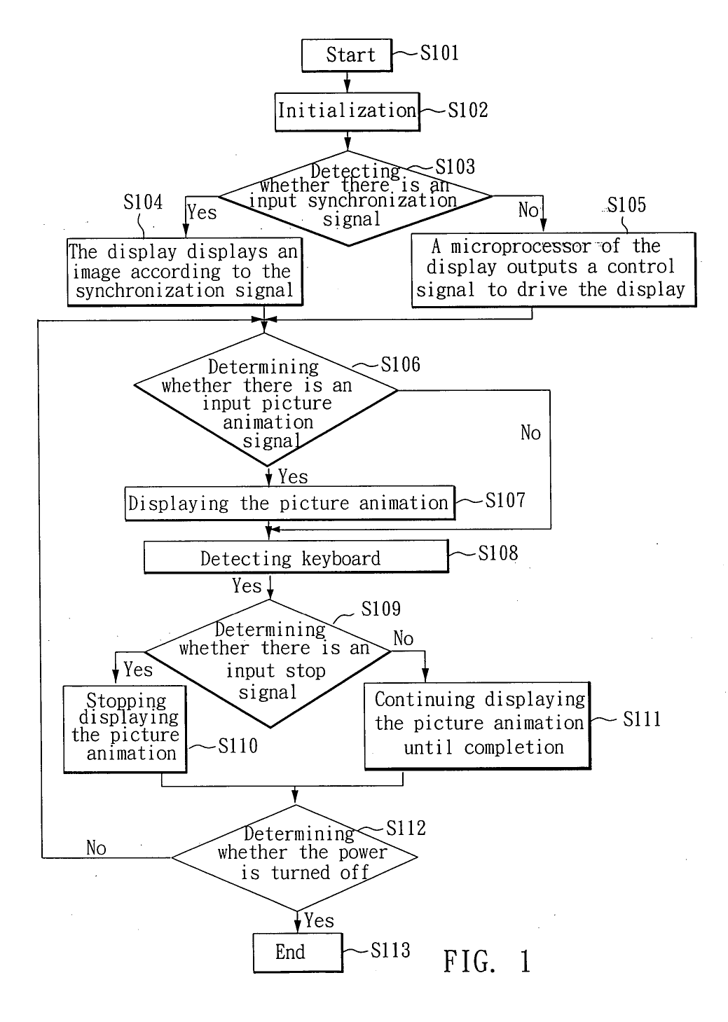

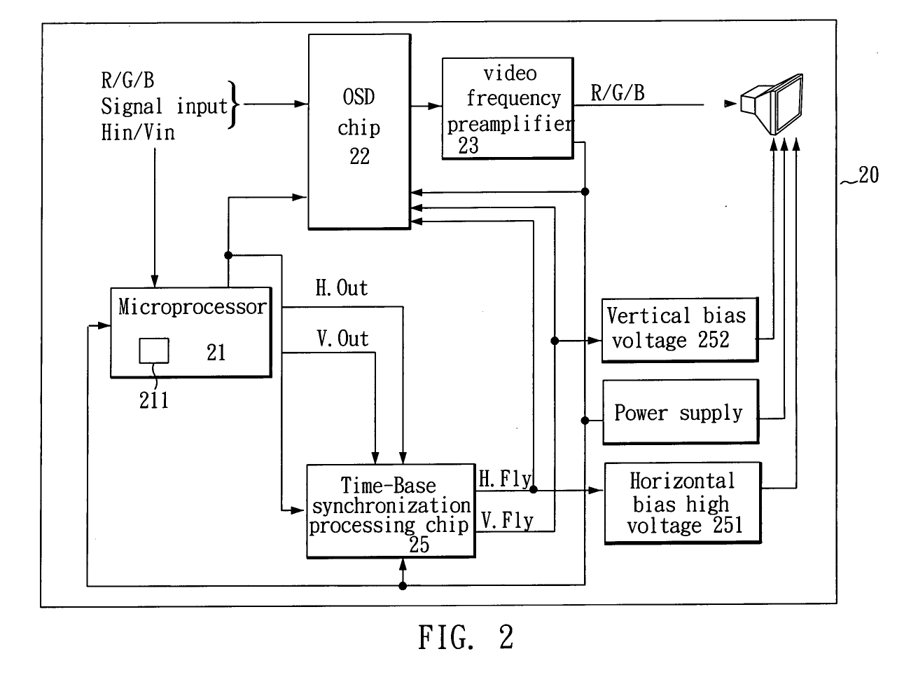

Please refer to FIG. 1 and FIG. 2. FIG. 1 is a flowchart of a preferred embodiment according to the present invention. FIG. 2 is a functional block drawing of a CRT display. The present invention provides a method for displaying picture animation. In this embodiment, the method is applied to a CRT display 20. A microprocessor 21 of the CRT display 20 comprises a re-writeable memory 211, which can be used for storing the picture animation.

First, when the CRT display 20 is turned on (step S101), the microprocessor 21 begins executing an initial process (step S102), and the CRT display 20 detects whether there is an input synchronization signal (step S103); if there is, the CRT display 20 displays an image according to the synchronization signal (step S104), next performs a picture quality tuning on the displayed picture, and then the microprocessor 21 determines whether there is an input picture animation signal (step S106). For example, if an OSD chip 22 receives a picture animation signal, the OSD chip 22 obtains the corresponding picture animation from the re-writeable memory 211 and sends the picture animation to a video frequency preamplifier 23 for output to the CRT for image generation, whereby the picture animation is displayed on the screen (step S107). In this embodiment, the picture animation is stored in the re-writeable memory 211 as hexadecimal program code. During a display process, execution for keyboard detection is performed (step S108), so as to detect whether there is a stop signal (step S109). In this embodiment, the stop signal is a signal from buttons and that signal can come from a keyboard of a computer host connected to the CRT display 20 or buttons on the CRT display 20. During the display process, if the microprocessor 21 receives any button input signal, it immediately stops displaying the picture animation (step S110); if there is no button input signal, the microprocessor 21 continues displaying the picture animation until such displaying comes to an end (step S111). When displaying of the picture animation has finished, the microprocessor 21 continues to detect if there is a request for repeating the picture animation and determining whether the power is turned off (step S112), which continues until the power is turned off (step S113).

Furthermore, in step S105, if there is no input synchronization signal, the microprocessor 21 outputs constant horizontal and vertical signals to a synchronization processing chip 25 to generate a horizontal bias high voltage 251 and a vertical bias voltage 252 to drive the CRT; the microprocessor 21 also determines whether the picture animation signal has been input (step S106). For example, if the OSD chip 22 receives a picture animation signal, the OSD chip 22 obtains the corresponding picture animation from the re-writeable memory 211 and sends the picture animation to the video frequency preamplifier 23 for output to the CRT for image generation to display the picture animation on the screen (step S107). During display processing, execution for keyboard detection is performed (step S108) to detect whether there is a stop signal (step S109). In this embodiment, the stop signal is a signal from buttons and which can come from a keyboard of a computer host connected to the CRT display 20 or buttons on the CRT display 20. During the display process, if the microprocessor 21 receives any button input signal, it immediately stops displaying the picture animation (step S110); if no button input signal is received, the microprocessor 21 continues displaying the picture animation until such display comes to an end (step S111). When displaying of the picture animation is complete, the microprocessor 21 continues detection of a request for repeating a display of the picture animation and determining whether the power is turned off (step S112), which continues until the power is turned off (step S113). When there is no input synchronization signal, an energy saving process is performed.

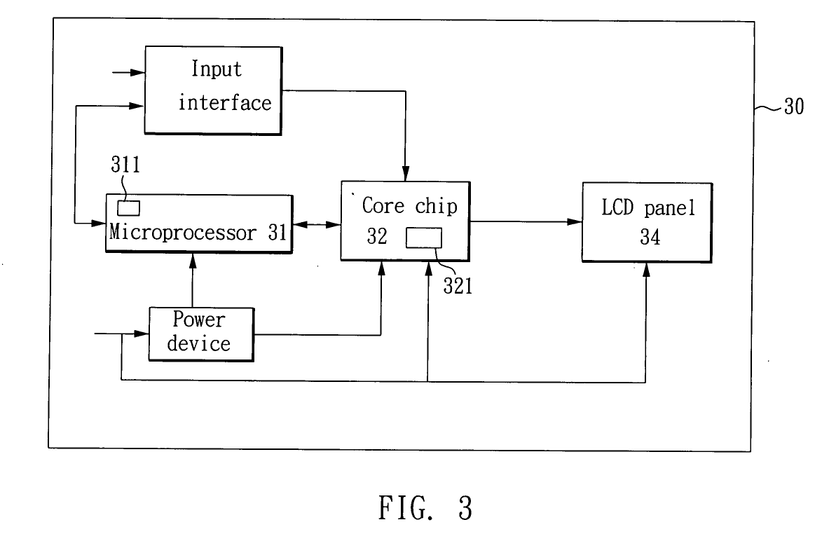

In another embodiment of the present invention, a picture animation is displayed on an LCD display. Please refer to FIG. 3 and FIG. 1. FIG. 3 is a functional block drawing of another preferred embodiment according to the present invention. This embodiment has operational processes similar to the previous embodiment, and achieves identical results. In this embodiment, when a synchronization signal is input, an LCD display 30 utilizes an OSD chip 321 in a core chip 32 to output the picture animation, and drives an LCD panel 34 to display the picture animation on a screen. In this embodiment, the picture animation can also be stored in a re-writeable memory 311 as a hexadecimal program code. When no synchronization signal is input, a microprocessor 31 controls the core chip 32 to generate horizontal and vertical data flow to drive the LCD panel 34 to display the picture animation. After display of the picture animation has finished, the microprocessor 31 controls the core chip 32 to terminate the horizontal and vertical data flow and executes an energy saving process.

This invention provides a method for displaying picture animation and utilizing execution of the OSD chip to present a picture animation, whereby both a power-on image from a computer and the monitor picture animation can be displayed at the same time. A user does not need to wait for the picture animation to finish displaying before seeing start-up information. Furthermore, the display can play the picture animation with or without use of a synchronization signal. Because the method of the present invention utilizes execution of the OSD chip to present a picture animation, both a power-on image from a computer and the monitor picture animation can be displayed at the same time. Thus, a user does not need to wait for the picture animation to finish displaying before seeing start-up information. Furthermore, by utilizing the re-writeable memory, the user can design the picture animation, or download the picture animation from a network.

Although the present invention has been explained in relation to its preferred embodiment, it is to be understood that many other possible modifications and variations can be made without departing from the spirit and scope of the invention as hereinafter claimed.

What is claimed is:

1. A method for displaying a picture animation on a display comprising:
(A) initialization;
(B) detecting whether there is an input synchronization signal; if there is an input synchronization signal, the display displays an image according to the synchronization signal; otherwise a microprocessor of the display outputs a control signal to drive the display;
(C) determining whether there is an input picture animation signal; if there is an input picture animation signal, the display displays the picture animation; and
(D) determining whether there is an input stop signal; if there is an input stop signal, display the picture animation is stopped; otherwise display of the picture animation is continued until completion;
wherein the picture animation is displayed by an OSD chip.

2. The method as claimed in claim 1, wherein in step (B), the control signal is a constant horizontal signal and a constant vertical signal.

3. The method as claimed in claim 1, wherein in step (D), the stop signal is a key input signal.

4. The method as claimed in claim 1, wherein the microprocessor of the display further comprises a re-writeable memory for storing the picture animation.

5. The method as claimed in claim 1, wherein the picture animation is hexadecimal program code.

6. The method as claimed in claim 1 further comprising a picture transmission tool for designing pictures or downloading pictures from the Internet.

7. The method as claimed in claim 1, wherein the display is a CRT display.

8. The method as claimed in claim 1, wherein the display is an LCD display.
